(19) United States
(12) Patent Application Publication
(10) Pub. No.: US 2011/0151811 A1
(43) Pub. Date: Jun. 23, 2011

(54) Wireless Device With Selectable Antennas

(76) Inventors: Isaac Lagnado, Houston, TX (US); Ming He, Houston, TX (US)

(21) Appl. No.: 13/060,102

(22) PCT Filed: Oct. 30, 2008
(86) PCT No.: PCT/US08/81878

§ 371 Date: Feb. 22, 2011

(51) Int. Cl. H04B 1/18; H01Q 21/30

(52) U.S. Cl. 455/150.1; 343/876

(57) ABSTRACT

Systems and methods for improving antenna performance and reducing antenna volume are disclosed herein. In one embodiment, a wireless communication device includes a first antenna, a second antenna, and a radio frequency receiver. The first antenna is tuned to support a first set of radio frequency bands. The second antenna is tuned to support a second set of radio frequency bands. The radio frequency receiver combines signals detected by the first and second antennas to produce a baseband signal. The second set of radio frequency bands is different from the first set of radio frequency bands.

### BACKGROUND

Portable wireless communication devices have become increasingly popular. In some applications, wireless interconnect is now considered a necessity rather than a convenience. The numerous advantages of wireless communications suggest that the trend towards wireless interconnection of electronic devices is unlikely to abate in the future.

Various frequencies of electromagnetic radiation have been adapted for use in wireless communications. The infra-red portion of the spectrum has generally been used for short-range line of sight applications. Visible light is sometimes used in similar applications. The portion of the electromagnetic spectrum below infra-red, i.e., radio frequencies (generally between audio and infra-red frequencies), is most often applied in wireless communication systems. Radio frequency communication is preferable to other wireless means, such as infra-red, in many applications because of its ability to traverse long distances and obstructions. Radio frequency wireless devices incorporate an antenna to enable conversion of electrical signals to electromagnetic waves and vice versa.

Some portable wireless devices include more than one antenna. The primary antenna may be referred to as the main antenna. The main antenna is generally the predominant antenna, and typically operates in all frequency bands of interest to the device. A secondary antenna, sometimes termed a diversity antenna, is usually reserved for application of diversity functions to received signals. The main and diversity antennas are generally disposed from one another by at least a quarter wavelength.

Diversity involves combining signals from the various antennas in such a manner as to “focus” the array on the transmitting device in some cases, or in other cases, to simply enhance sensitivity in certain directions while suppressing sensitivity in other directions. In wireless communications, the energy transmitted to a receiving device falls off rapidly as the distance from the transmitting device increases. The environment around the transmitting and receiving devices comprises various objects that cause reflection and attenuation. When a receiving device is provided with multiple antennas, the receiving device can employ diversity principles to enhance signal reception. Thus, multiple antennas can provide improved signal reception and more reliable wireless communications.

Various human factors must also be considered when designing a portable wireless device. Devices must be reasonably small and light to maintain their portability. Over time, the size and weight of portable devices, such as notebook computers, has been notably reduced and further reductions are likely in the future. Including multiple antennas to improve performance, tends to conflict with reductions in size and weight. Thus, small form-factor antenna systems that improve wireless performance are desirable.

### BRIEF DESCRIPTION OF THE DRAWINGS

For a detailed description of exemplary embodiments of the invention, reference will now be made to the accompanying drawings in which:

FIG. 1 shows an exemplary wireless system including a mobile wireless device comprising antenna switching in accordance with various embodiments;

FIG. 2 shows a block diagram of an exemplary wireless module including antenna switching in accordance with various embodiments;

FIGS. 3A, and 3B show illustrative performance graphs for antennas configured to cover the 800 megahertz (“MHz”) band, the 900 MHz band, and the 800-900 MHz band; and

FIG. 4 shows a flow diagram for a method for performing antenna switching in a wireless device in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Further, the term “software” includes any executable code capable of running on a processor, regardless of the media used to store the software. Thus, code stored in non-volatile memory, and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

The antennas deployed in small form factor wireless devices are being constrained to ever shrinking volumes. Antenna size is generally related to the wavelength (1/frequency) of the signal transmitted or received. Thus, antenna size is inversely proportional to the frequency band supported by the antenna. The volume occupied by an antenna, therefore, depends on the number of frequency bands the antenna covers, particularly the lower frequency bands. When an antenna is required to cover multiple frequency bands, reducing the size of the antenna becomes problematic. Embodiments of the present disclosure reduce the volume occupied by the antennas of a wireless communication device, by reducing the number of frequency bands covered by each antenna, and switching between antennas to make an antenna covering the frequency band of interest the main antenna.

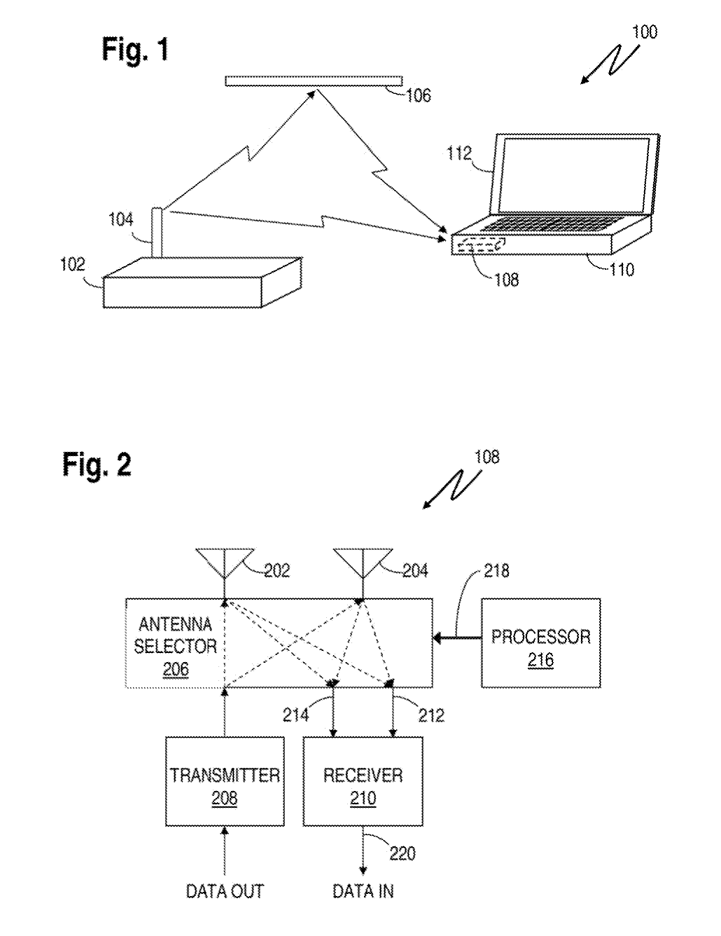

FIG. 1 shows an exemplary wireless system 100 including a mobile wireless device 110 comprising antenna switching in accordance with various embodiments. The system 100 includes a transmitting device 102, such as a cellular base station, a wireless router, etc., and a mobile wireless device 110, shown as a notebook computer. The transmitting device 100 includes an antenna 104 for transmission and reception of radio frequency signals. As a matter of convenience, only a single antenna 104 is illustrated, however, in practice the transmitting device 102 can include any number of antennas.

The antenna 104 couples a signal to the channel between the transmitting device 102 and the computer 110 by converting electrical signals to electromagnetic waves. Some transmitted signals may propagate through the channel directly to the computer 110. Other transmitted signals may be reflected off of various obstacles and reflective surfaces, such as obstacle 106, and consequently arrive at the computer 110 by a less direct path that results in increased signal attenuation and/or distortion.

The notebook computer 110 includes a wireless transceiver 108 for transmission and reception of radio frequency signals. The wireless transceiver 108 preferably includes a plurality of antennas. Each antenna is configured to transmit and receive using a specific subset of the total frequency bands over which the transceiver 108 is operable. For example, in some embodiments, a first antenna can be optimized to cover the 800 and 900 megahertz (“MHz”) bands, and a second antenna can be optimized to cover the 1.8, 1.9, and 2.1 gigahertz (“GHz”) bands. When operating in the 900 MHz band the first antenna is selected as the primary antenna and the second antenna serves as the diversity antenna. Likewise, when operating in the 1.8 GHz band the second antenna is selected as the primary antenna and the first antenna serves as the diversity antenna. The signals detected by the primary and diversity antennas can be combined to improve the overall reception of the transceiver 108. The wireless transceiver 108 and/or the antennas associated with the wireless transceiver 108 can be located anywhere within the computer 110 to optimize wireless communications. For example, in some embodiments the antennas are located at opposite corners of the display 112 to improve diversity.

By dividing the frequency bands of interest between the antennas, embodiments of the present disclosure advantageously reduce the size of the individual antennas. For example, the second antenna can be optimally sized in accordance with the shorter wavelengths it covers. The second antenna can therefore be significantly smaller than the first antenna resulting in a reduction of the total volume occupied by the antenna set.

In addition to the wireless transceiver 108, the computer 110 generally comprises a processor that executes software programs, storage devices, such as disks and/or semiconductor memory for storage of programs and data, operator interface devices, such as a keyboard, mouse, display, etc, various input/output devices, and busses that couple together the components of the computer 110.

FIG. 2 shows a block diagram of an exemplary wireless transceiver module 108 including antenna switching in accordance with various embodiments. The transceiver module 108 includes a first antenna 202, a second antenna 204, an antenna selector 206, a transmitter 208, and a receiver 210. While the embodiment illustrated includes only two antennas 202, 204, other embodiments can include more than two antennas. Antenna 202 is configured for operation with a specific set of signal wavelengths. For example, antenna 202 can be configured for operation at 800 MHz, 1.55 GHz, and 1.8 GHz. Antenna 204 is configured for operation at a set of signal wavelengths other than the wavelengths covered by antenna 202. For example, antenna 204 can be configured for operation at 900 MHz, 1.9 GHz, and 2.1 GHz.

The antennas 202, 204 are coupled to the antenna selector 206. The antenna selector includes switching circuitry, for example, a set of RF switches, to connect a selected antenna 202, 204 to the transmitter 208, and switching circuitry to connect the antennas 202, 204 to one of the primary antenna output and the diversity antenna output of the antenna selector 206. The antenna selector 206 is controlled via a control signal 218. In at least some embodiments, the control signal 218 can be provided by a processor 216, for example, a microprocessor, microcontroller, or digital signal processor that executes a software program stored in a memory device coupled to the processor. The processor and associated software can determine an optimal antenna configuration based on device (e.g., notebook 110) operating conditions. For example, if the device is to operate on a selected wireless network, the processor and associated software programming preferably select the antenna 202, 204 tuned to cover that network's frequency band to serve as the main antenna. The other of the two antennas is selected to serve as the diversity antenna. If the antennas 202, 204 are configured as described above, and the selected network operates in the 900 MHz band, then antenna 204 can be selected as the main antenna and antenna 202 selected as the diversity antenna. If, on the other hand, the selected network operates in the 800 MHz band, then antenna 202 can be selected as the main antenna and antenna 209 selected as the diversity antenna. In some embodiments, the processor 216, and associated software can be a component of the wireless transceiver 108, in other embodiments, for example the notebook computer 110, the processor 216 can be a central processor of the computer 110.

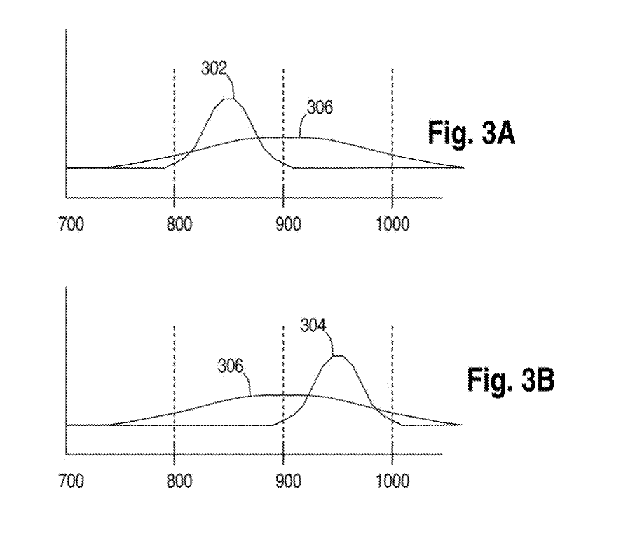

FIG. 3A shows a graphical representation of the performance 302 of antenna 202 focused primarily on the 800 MHz band. FIG. 3A also shows a representation of an antenna performance 306 required to cover a larger frequency spectrum, specifically the 800 MHz and 900 MHz bands. Similarly, FIG. 38 shows a graphical representation of the performance 304 of antenna 204 primarily focused on the 900 MHz band. FIG. 3B further illustrates the performance 306 of an antenna configured to cover both the 800 MHz and 900 MHz bands.

The tall curves 302, 304 in FIGS. 3A and 3B represent improved antenna resonance, which relates directly to improved antenna receive and/or transmit performance capability. By reducing the number of frequency bands each antenna 202, 204 is configured to cover, the performance of each antenna 202, 204 in its respective bands can be improved, as shown by the increased resonance of performance curves 304, 302 compared to curve 306. Thus, when operating, for example, in the 900 MHz band, antenna 204 (represented by performance 304) can be selected as the main antenna and, as shown in FIG. 3B, perform substantially better than an antenna configured to operate over both the 800 and 900 MHz bands (represented by performance 306). Furthermore, when operating in the 800 MHz band, the antenna 202 (represented by performance 302) can be selected as the main antenna and will provide improved performance over an antenna having performance 306.

A diversity antenna need not perform to the same level as a main antenna in order to provide full diversity benefit. Consequently, the performance 302 of antenna 202 in the 900 MHz band, as illustrated in FIG. 3A, is sufficient to provide diversity. Likewise, as shown in FIG. 3B, the performance 304 of antenna 204 will provide sufficient diversity performance for 800 MHz band operation.

Referring again to FIG. 2, the receiver 210 is provided with a main antenna output signal 212 and a diversity antenna signal output 214. The receiver 210 down-converts, filters, demodulates and processes the main antenna output signal 212 and the diversity antenna signal output 214 to improve the quality of the output baseband signal 220. Embodiments of the receiver 210 can, for example, select the strongest of the antenna inputs 212, 214 for processing, or combine the antenna inputs 212, 214 to produce a single improved combination signal.

Embodiments of the wireless module 108 allow each antenna 202, 204 to share the performance responsibility for a portion of the total frequency bands employed by a wireless device. The performance of each antenna 202, 204 is focused within specific frequency bands. By concentrating each antenna on specific frequency bands the performance of each antenna within its selected bands is improved, and the combined volume of the antenna system is reduced when compared to a set of multi-band antennas wherein each antenna is crafted to cover all bands of interest.

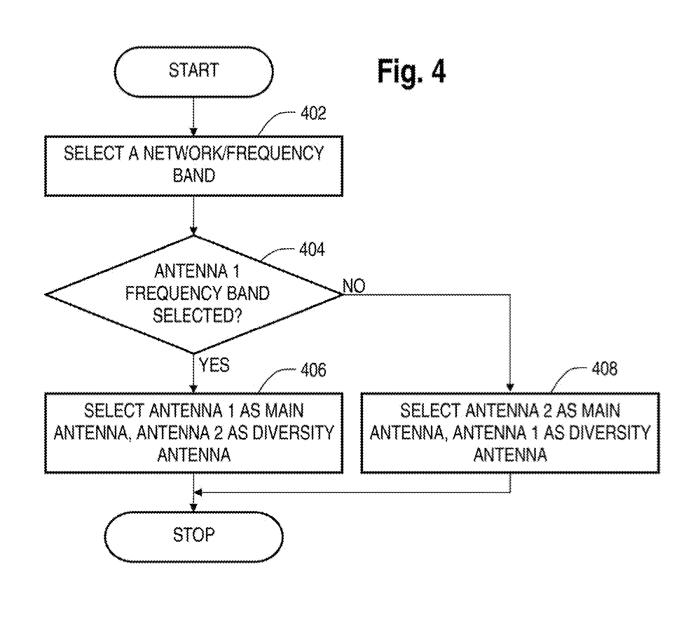

FIG. 4 shows a flow diagram for a method for performing antenna switching in a wireless device in accordance with various embodiments. Though depicted sequentially as a matter of convenience, at least some of the actions shown can be performed in a different order and/or performed in parallel. Additionally, some embodiments may perform only some of the actions shown.

In block 402, a wireless device 110 is connecting to a wireless network for communication. The wireless device 110 supports multiple RF frequency bands, and includes multiple antennas 202, 204. Each antenna supports a subset of the RF frequency bands supported by the device 110. A frequency band is selected, for example, by processor 216 and associated software programming, based on any one or more of various frequency band selection criteria, for example, user selection, network availability, signal strength, etc.

In block 404, a determination is made as to which of the device's multiple antennas 202, 204 is tuned to the selected frequency band. By concentrating each antenna 202, 204 on specific frequency bands the performance of each antenna 202, 204 within its selected bands is improved, and the combined volume of the antenna system is reduced when compared to a set of multi-band antennas wherein each antenna is crafted to cover all bands of interest.

If the selected radio band is supported by antenna, one 202, then, in block 406, the antenna selector 206 is configured to provide antenna one 202 as the main antenna, and antenna two 204 as the diversity antenna. If the selected radio band is not supported by antenna one 202, then, in block 408, the antenna selector 206 is configured to provide antenna two 204 as the main antenna and antenna one 202 as the diversity antenna.

The above discussion is meant to be illustrative of the principles and various embodiments of the present invention. Numerous variations and modifications will become apparent to those skilled in the art once the above disclosure is fully appreciated. For example, while as a matter of convenience, embodiments employing two antennas are discussed herein, those skilled in the art will recognize that embodiments are applicable to any number of antennas. Moreover, while discussed in the context of a notebook computer, embodiments of the present disclosure are applicable to a wide variety of devices employing wireless communications. It is intended that the following claims be interpreted to embrace all such variations and modifications.

What is claimed is:

1. A wireless communication device, comprising:
a first antenna tuned to support a first set of radio frequency bands;
a second antenna tuned to support a second set of radio frequency bands; and
a radio frequency receiver that combines signals detected by the first and second antennas to produce a baseband signal;
wherein the second set of radio frequency bands is different from the first set of radio frequency bands.

2. The wireless communication device of claim 1, wherein the first set of radio frequency bands and the second set of radio frequency bands are disjoint.

3. The wireless communication device of claim 1, wherein the first antenna serves as a main antenna and the second antenna serves as a diversity antenna when operating in a frequency band to which the first antenna is tuned, and the second antenna serves as the main antenna and the first antenna serves as the diversity antenna when operating in a frequency band to which the second antenna is tuned.

4. The wireless communication device of claim 1, further comprising an antenna selector that selectably switches one of the first and second antennas to serve as a main antenna and the other of the first and second antennas to serve as a diversity antenna.

5. The wireless communication device of claim 1, further comprising a processor coupled to an antenna selector, wherein the processor executes instructions that determine which of the first and second antennas serve as a main antenna and as a diversity antenna.

6. The wireless communication device of claim 1, wherein the radio bands of the first set are higher in frequency than the radio bands of the second set.

7. The wireless communication device of claim 6, wherein the first antenna occupies less space than the second antenna.

8. A radio module, comprising
a plurality of antennas, each antenna of the plurality of antennas is tuned to cover a different set of frequency bands; and
an antenna selector coupled to the plurality of antennas;
wherein each antenna can serve as a diversity antenna for each other antenna, and the antenna selector switchably couples the plurality of antennas to a receiver based, at least in part, on a selected frequency band.

9. The radio module of claim 8, wherein only one antenna of the plurality of antennas is tuned to cover each frequency band.

10. The radio module of claim 8, wherein each antenna can serve as a main antenna and a diversity antenna based on the selected frequency band, and an antenna serves as the main antenna when using a frequency band to which the antenna is tuned, and the antenna serves as a diversity antenna when using a frequency band to which the antenna is not tuned.

11. The radio module of claim 1, wherein a first antenna of the plurality of antennas covers a higher set of frequency bands than are covered by a second antenna of the plurality of antennas.

12. The radio module of claim 11, wherein the volume of the second antenna is greater than the volume of the first antenna.

13. A method, comprising:
selecting a frequency band in which a wireless device operates;
determining which of a first antenna and a second antenna, each of which can serve as a diversity antenna for the other, is tuned to support the frequency band, when the first antenna supports one set of frequency bands useable by the wireless device, and the second antenna supports a second set of frequency bands useable by the wireless device, and the first set is different than the second set.

14. The method of claim 13, further comprising selecting the first antenna to serve as a main antenna, and selecting the second antenna to serve as a diversity antenna.

15. The method of claim 13, further comprising selecting the second antenna to serve as a main antenna, and selecting the first antenna to serve as a diversity antenna.
